(19) United States
(12) Patent Application Publication
(10) Pub. No.: US 2008/0054085 A1
(43) Pub. Date: Mar. 6, 2008

(54) External air assisted building heating and cooling

(76) Inventor: Colin Cleo Case, Highlands Ranch, CO (US)

Correspondence Address: Colin C. Case, 10672 Stonington Street, Highlands Ranch, CO, 80126, US

(21) Appl. No.: 11/514,388

(22) Filed: Sep. 1, 2006

(51) Int. Cl. G05D 23/12

(52) U.S. Cl. 236/1 C

(57) ABSTRACT

An external air assisted building forced air heating system equipped with or without air conditioning that uses ducted external air to cool or heat a building instead of using other energy resources (like electricity and gas) when the temperature of the external air is less than the desired cooling temperature or greater than the desired heating temperature. If the heating system is not equipped with air conditioning, the building is only cooled when the outside air temperature is less than the desired inside temperature. A controller (normally referred to as a Programmable Thermostat) monitors the indoor and outdoor air temperature in order to control the building's heating and air conditioning system and the external air duct system.

### BACKGROUND OF THE INVENTION

The invention relates generally to the use of external air to supplement the functions of building forced air heating systems with and without integrated air conditioning. Building forced air heating systems with or without integrated air conditioning use energy (like electricity and gas) to heat and cool buildings regardless of the outside air temperature. The problem with current forced air heating and cooling systems is that they do not use external air to heat or cool a building when the external air temperature is higher than the desired heating temperature or when the external air temperature is lower than the desired building air conditioning temperature.

### BRIEF SUMMARY OF THE INVENTION

The invention is an external air assisted building forced air heating system equipped with or without integrated air conditioning that uses external air to heat the building when the external air temperature is higher than the desired building temperature and uses external air to cool the building when the external air temperature is lower than the desired building temperature. By using external air when appropriate, the system reduces its use of energy resources and thereby reduces its operations costs. A ducting system is required to provide external air to the forced air heating system equipped with or without air conditioning and to allow release of excessive internal air pressure. A controller (normally referred to as a Programmable Thermostat) is required to control the various parts of the system.

It is an object of the invention to provide an external air assisted building forced air heating system equipped with or without air conditioning that is less expensive to operate than systems that use exclusively mechanical and electrical energy to heat and cool buildings. Significant savings can be achieved in heating and cooling costs in those areas where the night time temperatures are normally less then the inside desired cooling temperatures and in those areas where the day time temperatures exceed the desired heating temperature for periods of time during the day.

### BRIEF DESCRIPTION OF THE SEVERAL VIEWS OF THE DRAWINGS

FIG. 1 is a labeled representation showing an external air assisted forced air heating system equipped with air conditioning including an active duct system for adding external air to the building heating and air conditioning system and a venting system for equalizing the air pressure in the building. A controller is shown that controls the entire configuration.

FIG. 2 is a labeled representation showing an external air assisted forced air heating system equipped with air conditioning including a passive duct system that adds air to the building heating and air conditioning system and provides a venting system for equalizing the air pressure in the building. A controller is shown that controls the entire configuration.

FIG. 3 is a labeled representation showing an external air assisted forced air heating system not equipped with air conditioning including an active duct system that adds air to the building heating system and provides a venting system for equalizing the air pressure in the building. A controller is shown that controls the entire configuration.

FIG. 4 is a labeled representation showing an external air assisted forced air heating system not equipped with air conditioning including a passive duct system that adds air to the building heating system and provides a venting system for equalizing the air pressure in the building. A controller is shown that controls the entire configuration.

### DETAILED DESCRIPTION OF THE INVENTION

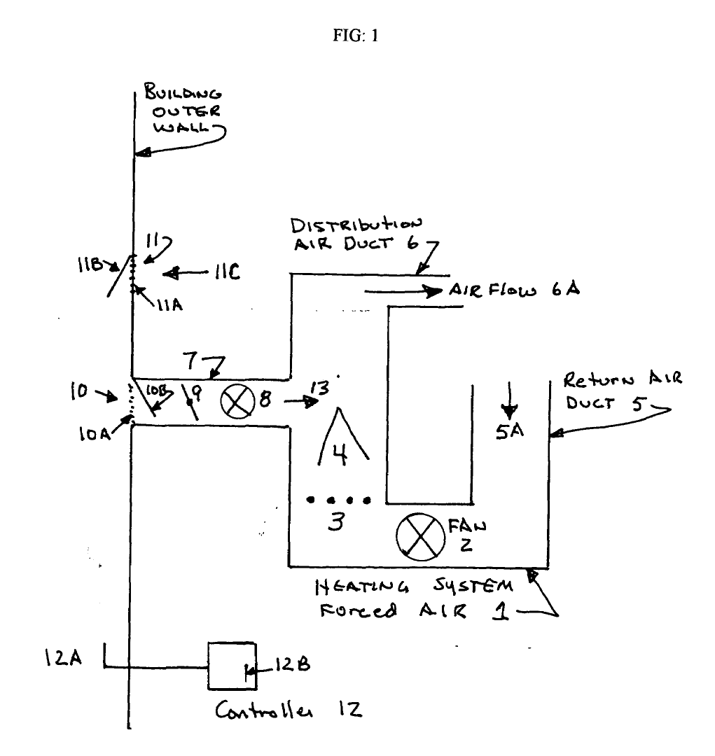

Referring to FIG. 1, a labeled representation is shown which represents an active duct embodiment of an external air assisted forced air building heating and air conditioning system equipped with a fan 2, a heating element 3, a cooling element 4, an air return duct 5, and an air distribution duct 6. Direction of air flow is shown by 6A and 5A. In this embodiment, a duct 7 equipped with a fan 8, and a baffle 9 provides access to external air through opening 10. Opening 10 has a screen 10A and a spring controlled flap 10B. Duct 7 is connected to the heating and air conditioning system 1 at duct 6 (or it could be connected to the return duct 5). An opening 11 to the external air provides venting of the excess air pressure 11C in the building and is equipped with a screen 11A and a spring controlled flap 11B. Controller 12 controls the heating and air conditioning elements 2, 3, and 4 and controls fan 8 and baffle 9 in order to draw outside air into the heating and air conditioning system when appropriate depending upon the outside air temperature (monitored by a thermometer 12A) and the desired air temperature (monitored by thermometer 12B) in the building. When the controller 12 decides outside air 13 should be drawn into the building's heating and air conditioning system, the controller turns fan 8 on, fan 2 on (if not already on) and opens baffle 9 which due to the flow of air (direction of air flow in this duct is shown by 13) opens flap 10B. At the same time the controller 12 turns the heating element 3 or the air conditioning element 4 off depending upon whether heating or cooling is being provided to the building. The air introduced by fan 8 through duct 7 flows into the building heating and air conditioning system 1 which with the aid of fan 2 distributes the air 6A throughout the building. Any excess air 11C introduced into the building then flows out through the opening 11 when flap 11B is pushed open by the increased air pressure. When external air is not being used the controller 12 turns fan 8 off and closes baffle 9 and the building heating and air conditioning system uses traditional energy sources (like gas and electricity) to heat and cool the building.

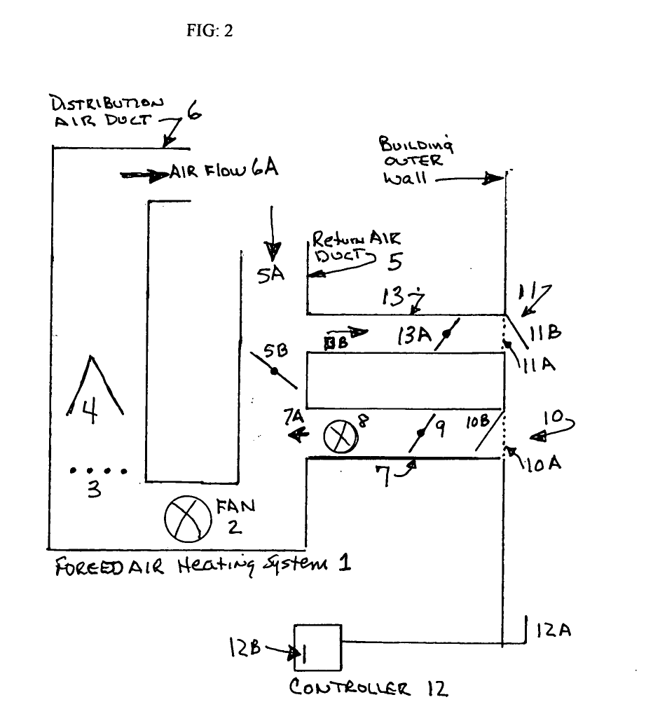

Referring to FIG. 2, a labeled representation is shown which represents a passive duct embodiment of an external air assisted building forced air heating system 1 equipped with fan 2, heating elements 3, and air conditioning 4. In this embodiment, two ducts 7 and 13 are connected to the air return duct 5 (or ducts 7 and 13 could be connected to the air distribution duct 6) to provide external air to the heating and air conditioning system and to provide venting of excess air pressure to the outside environment. Ducts 7, 13 and 5 (or it could be duct 6) are equipped with electrical baffles 9, 13A, and 5B which are operated by the controller 12. Ducts 7 and 13 are equipped with protective screens 10A and 11A and spring operated flaps 10B and 11B, respectively. Flaps 10B and 11B are closed when no external air is being used. When the controller 12 determines by monitoring the external temperature via thermometer 12A and the internal temperature via thermometer 12B that external air should be used to heat or cool the building, the controller 12 opens baffles 9 and 13A, closes baffle 5B, and turns fan 2 on if not already on, turns fan 8 on when provided, and turns the heating elements 3 off or the cooling element 4 off if these are already on. When this occurs, the heating and air conditioning fan 2 draws external air 7A in through duct 7 (which could be equipped with an optional fan 8 to assist in drawing in outside air), circulates the air 6A through out the building via duct 6 and returns the air 13B to outside via the air return duct 5 and duct 13. When the controller 12 determines that external air will not be used, the controller closes baffles 9 and 13A, turns fan 8 off when provided, opens baffle 5B, and turns on the heating elements 3 or the cooling element 4 when appropriate to heat or cool the building. When external air is not used, the building heating and air conditioning system uses traditional energy sources to heat or cool the building.

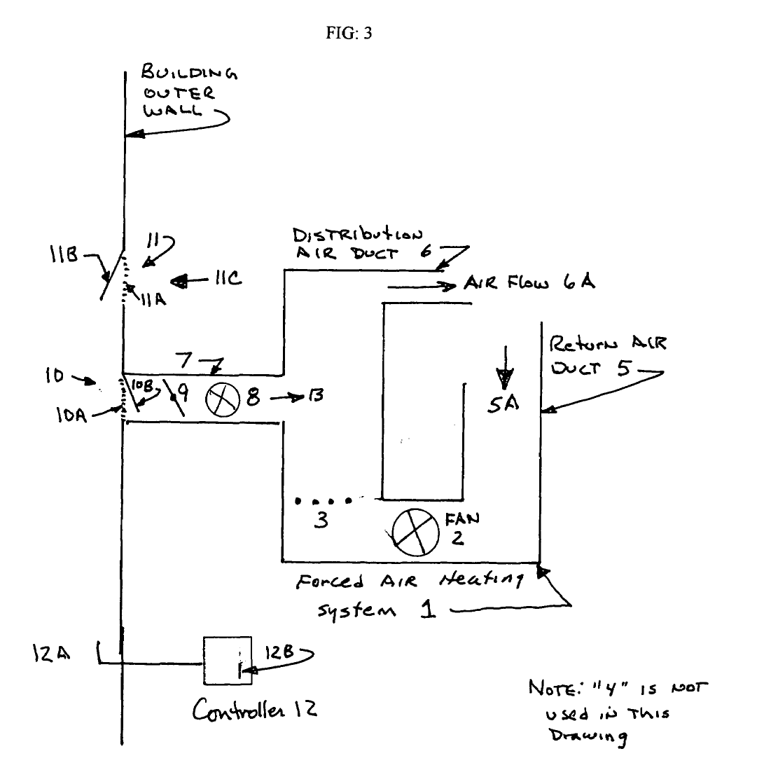

Referring to FIG. 3, a labeled representation is shown which represents an active duct embodiment of an external air assisted forced air building heating system 1 with a fan 2, a heating element 3, a return duct 5, and an air distribution duct 6. There is no air conditioning element in this embodiment. Direction of air flow in the system is shown by 6A and 5A. In this embodiment, a duct 7 equipped with a fan 8 and baffle 9 provides access to external air through opening 10. Opening 10 has a screen 10A and a spring controlled flap 10B. Duct 7 is connected to the heating system 1 at duct 6 (or it could be connected to the return duct 5). An opening 11 to the external air provides venting of the excess air pressure 11C in the building and is equipped with a screen 11A and a spring controlled flap 11B. Controller 12 controls the heating element 3, fan 2, and controls fan 8 and baffle 9 in order to draw outside air 13 into the heating system when appropriate depending upon the outside air temperature (monitored by a thermometer 12A) and the desired air temperature in the building (monitored by thermometer 12B). When the controller decides outside air should be drawn into the building's heating system in order to heat or cool the building, the controller turns heating element 3 off if on, turns fan 2 on if not already on, turns fan 8 on, and opens baffle 9 which due to the flow of air (direction of air flow in this duct is shown by 13) opens flap 10B. The air introduced by fan 8 through duct 7 flows into the building heating system 1 which distributes the air throughout the building. Any excess air 11C introduced into the building then flows out through the opening 11 when flap 11B is pushed open by the increased air pressure. When external air is not being used, the controller turns fan 8 off and closes baffle 9 and the building heating system uses traditional energy sources (like gas and electricity) to heat the building. In this embodiment, cooling is not provided when the outside air temperature exceeds the desired inside temperature.

Note that the number “4” is not used in this drawing.

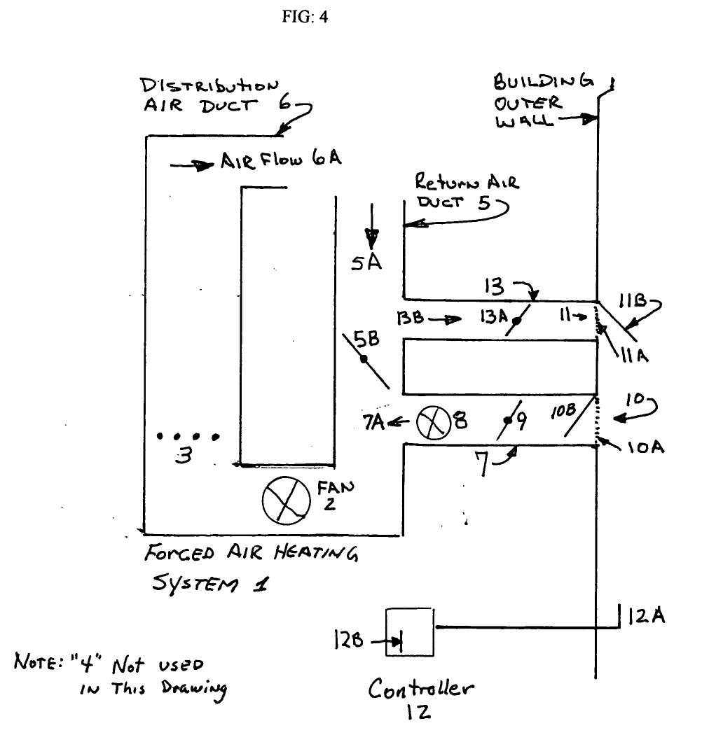

Referring to FIG. 4, a labeled representation is shown which represents a passive duct embodiment of an external air assisted building forced air heating system 1 with a fan 2, heating elements 3, a return duct 5, and an air distribution duct 6. In this embodiment, an air conditioning element is not provided. In this embodiment, two ducts 7 and 13 are connected to the return duct 5 (or ducts 7 and 13 could be connected to the air distribution duct 6) to provide external air to the heating system and to provide venting of excess air pressure to the outside environment. Ducts 7, 13, and 5 (or it could be duct 6) are equipped with electronically controlled baffles 9, 13A, and 5B which are operated by the controller 12. Duct 7 can be equipped with an optional fan 8. Ducts 7 and 13 are equipped with protective screens 10A and 11A and spring operated flaps 10B and 11B, respectively. Flaps 10B and 11B are closed when no external air is being used. When the controller 12 determines by monitoring the external temperature via thermometer 12A and the internal temperature via thermometer 12B that external air should be used to heat or cool the building, the controller opens baffles 9 and 13A, closes baffle 5B, turns fan 8 on if provided, turns fan 2 on if not already on and turns heating elements 3 off if already on. When this occurs, the heating system fan 2 draws external air 7A in through duct 7 (an optional fan 8 is shown in duct 7 to assist in drawing in outside air), circulates the air 6A through out the building via duct 6 and returns the air 13B to outside via the return duct 5 and duct 13. When the controller determines that external air will not be used, it closes baffles 9 and 13A, opens baffle 5B, turns fan 8 off if provided, and turns the heating elements 3 on if appropriate. When external air is not used, the building heating system uses traditional energy sources to heat the building. In this embodiment, cooling is not provided when the outside air temperature exceeds the desired inside temperature.

Note that the number “4” is not used in this drawing.

The simplicity or complexity of each external air duct system and the features required in the controller will depend on the economics of each specific embodiment.

I claim:

1. An external air assisted building forced air heating system with and without integrated air conditioning that comprises:
a. Means for conducting external air to the building heating and air conditioning system.
b. Means for conducting internal building air to the external environment when required to relieve internal air pressure.
c. A controller that monitors the external air and internal building air temperatures in order to control the building's heating system equipped with or without integrated cooling system and to control the external air conduction system.

2. An external air assisted building forced air heating system equipped with integrated air conditioning system as recited in claim 1, in which the external air conduction system comprises:
a. An incoming air opening in the building's wall equipped with a screen and spring controlled flap;
b. A properly sized duct connecting the opening recited in claim 2a to the building's heating and air conditioning system air distribution or air return duct;
c. An electronically controlled fan in the duct recited in claim 2b which draws air into the building heating and air conditioning system;
d. An electronically controlled baffle in the duct recited in claim 2b;
e. An outgoing air opening in the building's wall equipped with a screen and spring controlled flap for excessive building air pressure release;
f. A controller (normally referred to as a Programmable Thermostat) that monitors the indoor and outdoor temperatures in order to control the building's heating and air conditioning system and to control the fan recited in claim 2c and the baffle in claim 2d.

3. An external air assisted building forced air heating system equipped with integrated air conditioning system as recited in claim 1, in which the external air conduction system comprises:
a. An outgoing air opening in the building equipped with a screen and spring controlled flap;
b. A properly sized duct connecting the opening recited in claim 3a to the building's heating and air conditioning system air return or distribution duct;
c. An electrically controlled baffle located inside the duct recited in claim 3b;
d. An incoming air opening in the building equipped with a screen and spring controlled flap;
e. A properly sized duct connecting the opening recited in claim 3d to the building's heating and air conditioning systems air return or distribution duct;
f. An electronically controlled baffle located inside the duct recited in claim 3e;
g. An optional electronically controlled fan located inside the duct recited in claim 3e;
h. An electronically controlled baffle located inside the building's heating and air conditioning system air return or distribution duct;
i. A controller (normally referred to as a Programmable Thermostat) that monitors the indoor and outdoor air temperatures in order to control the building's heating and air conditioning system, the optional fan recited in 3g when provided, the baffles in the ducts recited in claims 3c and 3f, and the baffle in the building's heating and air conditioning system return or distribution air duct as recited in claim 3h.

4. An external air assisted building forced air heating system without an integrated air conditioning system as recited in claim 1, in which the external air conduction system comprises:
a. An incoming air opening in the building's wall equipped with a screen and spring controlled flap;
b. A properly sized duct connecting the opening recited in claim 4a to the building's heating system air distribution or air return duct;
c. An electronically controlled fan in the duct recited in claim 4b which draws air into the building heating system;
d. An electronically controlled baffle in the duct recited in claim 4b;
e. An outgoing air opening in the building's wall equipped with a screen and spring controlled flap to provide excessive building air pressure release;
f. A controller (normally referred to as a Programmable Thermostat) that monitors the indoor and outdoor temperatures in order to control the building's heating system and to control the fan recited in claim 4c and the baffle recited in claim 4d.

5. An external air assisted building forced air heating system without an integrated air conditioning system as recited in claim 1, in which the external air conduction system comprises:
a. An outgoing air opening in the building equipped with a screen and spring controlled flap;
b. A properly sized duct connecting the opening recited in claim 5a to the building's heating and air conditioning system return or distribution air duct;
c. An electronically controlled baffle located inside the duct recited in claim 5b;
d. An incoming air opening in the building equipped with a screen and spring controlled flap;
e. A properly sized duct connecting the opening recited in claim 5d to the building's heating and air conditioning systems air return or distribution duct;
f. An electronically controlled baffle located inside the duct recited in claim 5e;
g. An optional electronically controlled fan located inside the duct recited in claim 5e;
h. An electronically controlled baffle located inside the building's heating system air return or distribution duct;
i. A controller (normally referred to as a Programmable Thermostat) that monitors the indoor and outdoor air temperatures in order to control the building's heating system, the baffles in the ducts recited in claims 5c and 5f, the optional fan recited in claim 5g if provided, and the baffle in the building's heating system return or distribution air duct as recited in claim 5h.
